(19) United States
(12) Patent Application Publication
(10) Pub. No.: US 2021/0257744 A1
(43) Pub. Date: Aug. 19, 2021

(54) AN ANTENNA ARRANGEMENT, A RADIATING ELEMENT AND A METHOD OF MANUFACTURING THE RADIATING ELEMENT

(71) Applicant: CELLMAX TECHNOLOGIES AB, Kista (SE)

(72) Inventors: Dan KARLSSON, Sollentuna (SE); Stefan JONSSON, Östersund (SE)

(21) Appl. No.: 16/973,177

(22) PCT Filed: Jun. 5, 2019
(86) PCT No.: PCT/SE2019/050525

§ 371 Date: Dec. 8, 2020

(30) Foreign Application Priority Data
Jun. 8, 2018 (SE) 1850698-0

(51) Int. Cl. H01Q 19/10; H01Q 15/00; H01Q 1/24; H01Q 21/00; H01Q 21/08

(52) U.S. Cl. CPC H01Q 19/108; H01Q 15/0033; H01Q 21/08; H01Q 21/0006; H01Q 21/0087; H01Q 1/246

(57) ABSTRACT

An antenna arrangement comprising an antenna feeding network, an electrically conductive reflector and at least one radiating element arranged on said reflector is provided. The radiating element a first part made of a first metallic material and a second part being provided in the lower part of the radiating element for connecting the radiating element to the reflector; wherein the second part is made of a second metallic material being different than the first metallic material. There is also provided a radiating element and a method of manufacturing the radiating element.

### TECHNICAL FIELD

The present invention relates to an antenna arrangement for mobile communications, which antenna arrangement comprises an antenna feeding network, an electrically conductive reflector and at least one radiating element arranged on the reflector. The present invention also relates to the radiating element and to a method of manufacturing the radiating element.

### BACKGROUND OF THE INVENTION

Multi-radiator antennas are frequently used in for example cellular networks. Such multi-radiator antennas comprise a number of radiating antenna elements comprising for example dipoles for sending or receiving signals, an antenna feeding network and an electrically conductive reflector. The antenna feeding network distributes the signal from a common coaxial connector to the radiators when the antenna is transmitting and combines the signals from the radiators and feeds them to the coaxial connector when receiving. A possible implementation of such a feeding network 2 is shown in FIG. 1.

In such a network, if the splitters/combiners consist of just one junction between 3 different 50 ohm lines, impedance match would not be maintained, and the impedance seen from each port would be 25 ohm instead of 50 ohm. Therefore, the splitter/combiner usually also includes an impedance transformation circuit which maintains 50 ohm impedance at all ports.

A person skilled in the art would recognize that the feeding network is fully reciprocal in the sense that transmission and reception can be treated in the same way, and to simplify the description only the transmission case is described below.

The antenna feeding network may comprise a plurality of parallel substantially air filled coaxial lines, each coaxial line comprising a central inner conductor at least partly surrounded by an outer conductor with insulating air in between. The coaxial lines and the reflector may be formed integrally with each other. The splitting may be done via crossover connections between inner conductors of adjacent coaxial lines. In order to preserve the characteristic impedance, the lines connecting to the crossover element include impedance matching structures. The substantially air filled coaxial lines may be provided with a dielectric element to provide a phase shifting arrangement. The phase shift is achieved by moving the dielectric element that is located between the inner conductor and the outer conductor of a coaxial line. If the dielectric element is moved in such a way that the outer conductor will be more filled with dielectric material, the phase shift will increase. WO2009/041896 discloses an antenna arrangement provided with an adjustable differential phase shifter using such a movable dielectric element.

The radiating element of an antenna typically is comprised of a dipole and a balun part. A dipole usually may consist of two radiating parts having an electrical length of approximately one quarter of a wavelength at the operating frequency and extending essentially in plane parallel with the antenna reflector, and positioned approximately at a distance equivalent to one quarter of a wavelength at the operating frequency. The radiating parts of the dipole are fed in counter-phase. The radiation from the dipole may be concentrated in one direction by placing the dipole above the conductive reflector plane, at a height of approximately a quarter wavelength at the operating frequency above the reflector.

The balun, also called balanced-unbalanced transformer, is used to feed the radiating parts of the dipole in counter-phase. In the radiating element, it is often convenient to also use the balun as a mechanical support of the two radiating parts of the dipole. The balun is often also used as an impedance matching element.

In telecommunications antennas, generally two dipoles may be combined to radiate signals with two different polarisations. These polarisations typically need to be orthogonal, and thus the two dipoles extend in the same plane essentially parallel with the reflector, but in directions perpendicular to each other. In such an implementation one balun is needed for each dipole, but can be combined into one mechanical part.

The balun includes an inner conductor and an outer conductor. The outer conductor serves as mechanical support for the dipole. The top side of the balun is connected to the radiating parts forming the dipole, where one of the radiating parts of the dipole is connected to the balun's outer conductor, or balun body, and the other radiating part of the dipole is connected to the balun's inner conductor. At the bottom side of the radiating element, the balun inner conductor is connected to the feeding network inner conductor, and the balun outer conductor, or balun body, is connected to the antenna reflector and to the feeding network outer conductor.

In prior art document WO2017/048181 A1 it is shown how the balun inner conductor can be capacitively connected to the inner conductor of the feeding network. The balun inner conductor can also be connected galvanically.

The feeding network can be implemented as having air-filled coaxial lines where the coaxial lines outer conductor which are an integrated part of the reflector as shown in e.g. prior art document WO2005/101566 A1, or flexible or semi-flexible cables can be used as described in prior art document WO2005/060049 A1, or using other technologies such as striplines or microstrip lines. The main difference between the first type of feeding network and one using e.g. flexible or semi-flexible cables is that in the latter case, the coaxial line outer conductor is often soldered directly to the outer conductor of the balun.

In another possible implementation, the air-filled coaxial lines forming the feeding network are not an integrated part of the reflector.

In yet another implementation, the feeding network is built using flexible or semi-flexible coaxial, or a combination of air-filled coaxial lines and flexible or semi-flexible coaxial lines.

A radiating element may be mechanically fixed to the reflector using tightening means, such as a screw or any suitable fastener (e.g. bolt). The screw will press the bottom of the radiating element, which is also the balun bottom side, against the reflector which also acts as the feeding network outer conductor. Thus, a galvanic connection may be established between the bottom side of balun outer conductor and the reflector and at the same time with the feeding network outer conductor.

A key parameter for a communication antenna is that it should generate as little Passive Inter-Modulation (PIM) as possible. PIM is a well-known phenomenon for a person skilled in the art. PIM is typically measured using two tones with 20 W (+43 dBm) each. A requirement commonly used in the industry is that PIM should be below −110 dBm.

When two strong Radio Frequency (RF) signals are sent through the antenna feeding network to the radiating element, whenever they encounter non-linearities, “new” signals are generated at frequencies which are the sum or difference of multiples of the two input signals. These “new” signals are known as intermodulation products, and if no active components, such as transistors, are responsible for generating those intermodulation products, they are called passive intermodulation products, and often referred to as PIM. These intermodulation products may be present at the frequency used for reception, and in this case, they will mask weak received signals, and thus reduce the radio system sensitivity. Lower sensitivity results in less coverage or lower data throughput. It is virtually impossible to produce passive networks or components which do not generate PIM, so the aim when designing e.g. antennas is to have so low PIM as possible, in order not to reduce the performance of the telecommunication system.

Non-linearities in the feeding network or passive components are often caused by poor connections between two metal parts in the sense that the impedance will vary depending on RF voltage or current magnitude. This can be seen when two conductors are pressed together in order to make a galvanic contact. Roughness in the connecting surfaces, or an oxide layer on one or both connecting surfaces will be seen as non-linearities and can generate PIM. One way to reduce PIM is by increasing the contact surface pressure in order to even up the surface or break through the oxide layer. The pressure applied to the surfaces is often obtained by a screw joint and by tightening the screw with a high torque. The usable pressure is often limited by the strength of the thread. One way to improve the contact surface pressure is to reduce the contacting areas as much as possible, thus the contact pressure is increased without increasing the force applied by the screw.

It is important that enough contact pressure is maintained during the antennas active life, typically 5-10 years, otherwise the PIM performance will be degraded. When pressure is applied by the screw, the material in the reflector and the material in the radiating element are subject to deformation. Deformation can be elastic, e.g. the material will strive to regain its previous shape, and thus maintain the contact pressure. The deformation can be plastic, e.g. the material will adapt its shape because of the pressure. If the plastic deformation only takes place when tightening the screw, this plastic deformation will only serve to even out roughness or break through an oxide layer, and will improve the PIM performance, but if the plastic deformation is time dependent, and continues after the screw has been tightened, the pressure exercised by the screw will be reduced, and PIM may increase. Such a time dependent plastic deformation is called creep; creep is defined as the time-dependent strain that takes place under a given load.

Creep in metal is typically related to the difference in temperature between the melting temperature of the metal and the temperature of operation. If this difference in temperature is lower, the creep will typically be higher than if the difference in temperature is higher.

A typical metal material for manufacturing a reflector is aluminium in the form of a sheet or an extrusion. Aluminium has a low tendency to creep and is a good material to be used for maintaining the contact pressure. The radiating element which often has a complicated shape, is often best manufactured using a die casting process. Aluminium can be die casted, but it is difficult and expensive to die cast aluminium in complicated shapes because draft angles cannot be small, and the tool dies will typically wear out after a few hundred thousand produced units, so if die casting a radiating element, it is often required to also machine it after it has been die casted. This makes the manufacturing process complex, time-consuming and expensive. Further, since an antenna arrangement usually includes many radiating elements the cost of the antenna will be high.

Brass is another material which can advantageously be used to make low PIM contacts between metal parts as it has good creep properties. However, brass is not easily die-casted because draft angles cannot be small, and the tool dies will wear out after typically a hundred thousand produced units.

Another metallic material that can be used for manufacturing radiating elements is zinc due to that zinc is an excellent material for die casting because draft angles can be made small, and the tool dies will wear out slowly and can typically produce in the order of a million units or more.

An antenna with zinc radiating elements can be manufactured that fulfill the PIM requirements of −110 dBm or lower. This was tested, and as expected, just after the antenna has been manufactured and the holding screw has been tightened with a suitable torque or force, the measured PIM was below −110 dBm. However, when tested again a week later, the PIM performance seriously degraded, and was well above −110 dBm. It is expected that the PIM performance, for such an arrangement, deteriorates even more after a longer time period. This is due to the fact that zinc has poor performance in terms of creep, and will not maintain/endure enough pressure to keep good PIM performance.

### SUMMARY OF THE INVENTION

It is an object of the embodiments of the present invention to solve the above problems by providing an antenna arrangement, a radiating element and a method of manufacturing a radiating element according to the independent claims. Preferred embodiments are defined in the dependent claims.

According to an aspect of the invention, there is provided an antenna arrangement comprising an antenna feeding network, an electrically conductive reflector and at least one radiating element arranged on said reflector, the radiating element comprising radiating parts, forming a dipole, and a balun part; said radiating element having a first part being made of a first metallic material. The radiating element is characterized in that it comprises a second part made of a second metallic material being different than the first metallic material, said second part being provided in the lower part of the radiating element for connecting the radiating element to the reflector.

According to another aspect of the invention, there is provided a radiating element for the antenna arrangement comprising an antenna feeding network and an electrically conductive reflector; the radiating element comprising radiating parts, forming a dipole, and a balun part; said radiating element having a first part being made of a first metallic material; the radiating element further comprises a second part being provided in the lower part of the radiating element for connecting the radiating element to the reflector; wherein the second part is made of a second metallic material being different than the first metallic material.

According to an embodiment, the second metallic material has less creep than the first metallic material and the first metallic material has a lower melting temperature that the second metallic material.

In other words, one or more radiating elements of the antenna arrangement is made of a combination of two different metallic materials exhibiting different properties in terms of at least creep and melting temperatures, in order to achieve and manufacture a low-cost radiating element that also has good PIM performance thereby avoiding reduction in the performance, in terms of coverage and/or throughput, of a telecommunication system employing the antenna arrangement.

According to an embodiment the first metallic material is a zinc-based material and the second metallic material is an aluminium-based material or a copper-based material such as brass.

According to an embodiment, the second part, being of the second metallic material, is made as an insert element in the bottom part of the balun part of the radiating element. This insert element may be galvanically connected to the bottom part of the balun part or capacitively connected to the bottom part of the balun part.

According to yet another aspect of the invention, there is provided a die casting method or process for manufacturing a radiating element for said antenna arrangement. The method includes: placing the insert element in a die cast mold cavity representing (the form of) the radiating element and forcing the first metallic material under high pressure, in molten form, into the mold cavity, wherein the insert element is made of the second metallic material being different than the first metallic material as explained above.

Additional embodiments not mentioned above will be described in the detailed description in conjunction with the drawings.

As mentioned earlier, several advantages are achieved by the invention, which include: low manufacturing cost of the radiating elements exhibiting good PIM performance. As a result, the performance, in terms of coverage and/or throughput, of a telecommunications system employing the antenna arrangement is not reduced.

Another advantage is that the manufacturing of a radiating element does not require machining after it has been die casted, i.e. it is not required to cut or shape the die casted radiating element with a rotating tool or by any other method.

Yet another advantage achieved by the invention is that the performance of the antenna arrangement is maintained during its active life.

Other advantages achieved by the present invention will be further described in the detailed description.

### BRIEF DESCRIPTION OF THE DRAWINGS

The present invention will now be described, for exemplary purposes, in more detail by way of embodiments and with reference to the enclosed drawings, in which:

FIG. 1 schematically illustrates a feeding network of an antenna arrangement;

FIG. 2 illustrates a perspective view of a prior art antenna arrangement;

FIG. 3 illustrates a perspective view of a portion of the antenna arrangement including three radiating elements;

FIG. 4 illustrates a cross view of a section of one radiating element on a reflector of the portion of FIG. 3.

FIG. 5A illustrates a cross view of a section of a radiating element connected to a reflector, according to an aspect of the present invention.

FIG. 5B illustrates a cross view of a section of a radiating element connected to a reflector, according to another aspect of the present invention,

FIG. 6A illustrates and example of an insert element suitable for use in the radiating element according to the present invention.

FIG. 6B illustrates and example of a brass washer suitable for use in the antenna arrangement according to the present invention.

### DETAILED DESCRIPTION OF PREFERRED EMBODIMENTS

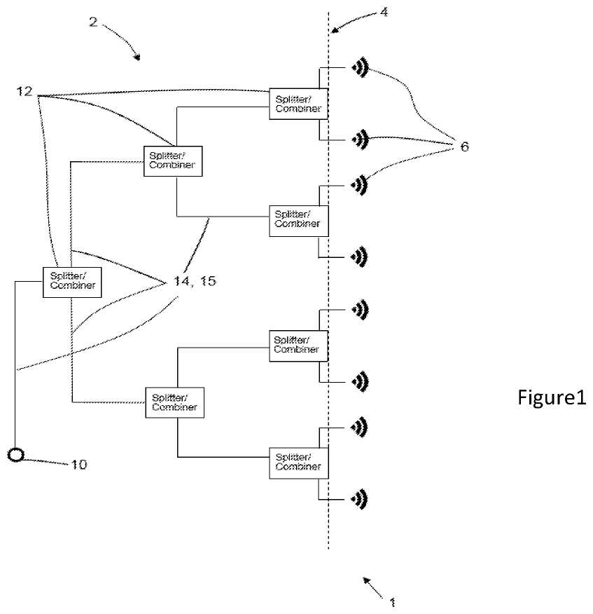

FIG. 1 schematically illustrates an antenna arrangement 1 comprising an antenna feeding network 2, an electrically conductive reflector 4, which is shown schematically in FIG. 1, and a plurality of radiating elements 6. Each radiating element 6 comprises radiating parts in the form of dipoles.

The antenna feeding network 2 connects a coaxial connector 10 to the plurality of radiating elements 6 via a plurality of lines or conductors 14, 15, which may be coaxial lines, which are schematically illustrated in FIG. 1. The signal to/from the connector 10 is split/combined using, in this example, three stages of splitters/combiners 12.

The antenna feeding network shown is used for feeding single polarisation radiating elements. In case dual polarisation radiating elements are used, the feeding network will be duplicated for the second polarisation.

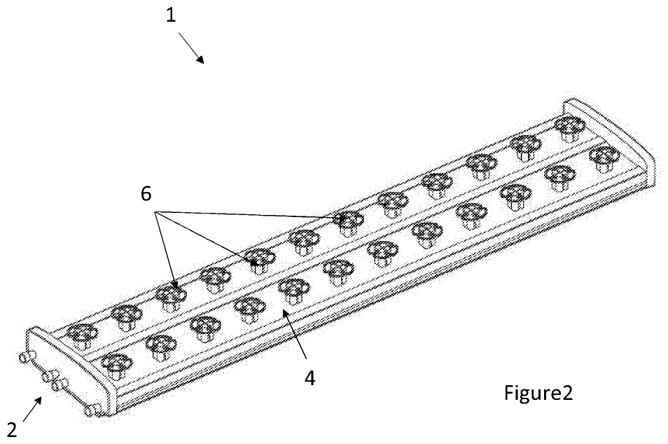

Turning now to FIG. 2, which illustrates a 3D perspective view of the antenna arrangement 1 comprising the feeding network 2, the electrically conductive reflector 4 and the radiating elements 6. Here, the antenna arrangement 1 is shown comprising 24 radiating elements. It should be noted that the antenna arrangement according to the present invention is not restricted to any particular number of radiating elements 6.

The electrically conductive reflector 4 comprises a front side, where the radiating elements 6 are mounted and a back side (not shown).

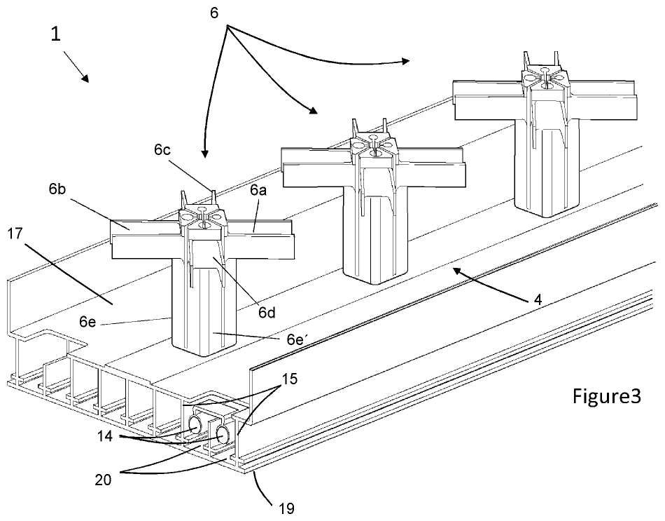

FIG. 3 depicts a perspective view of a portion of the antenna arrangement 1 of FIG. 2 including three radiating elements 6. FIG. 3 also shows two coaxial lines 20, each comprising a central inner conductor 14, an elongated outer conductor 15 forming a cavity or compartment around the central inner conductor 14. The outer conductors 15 have rectangular cross sections and are formed integrally and in parallel to form a self-supporting structure. The wall which separates the coaxial lines 20, constitute vertical parts of the outer conductors 15. The outer conductors 15 are formed integrally with the reflector 4 in the sense that the upper and lower walls of the outer conductors are formed by the front side 17 and the back side 19 of the reflector, respectively.

Although the inner conductors 14 are illustrated as neighbouring inner conductors they may actually be further apart thus having one or more coaxial lines, or empty cavities or compartments, in between. In addition, the embodiments herein are not restricted to any particular number of conductors and coaxial lines, radiating elements, etc.

In FIG. 3, not all longitudinal channels or outer conductors are illustrated with inner conductors. It is however clear that they may comprise such inner conductors.

Each of the radiating elements 6 is configured to be electrically connected to at least one of the inner conductors 14 via, e.g. coupling element(s) (not shown).

As shown in FIG. 3, each radiating element 6 comprises a first part composed of four identical radiating parts 6a-6d forming a dipole and the balun 6e. Note that the radiating element 6 may include fewer than four or more than 4 radiating parts.

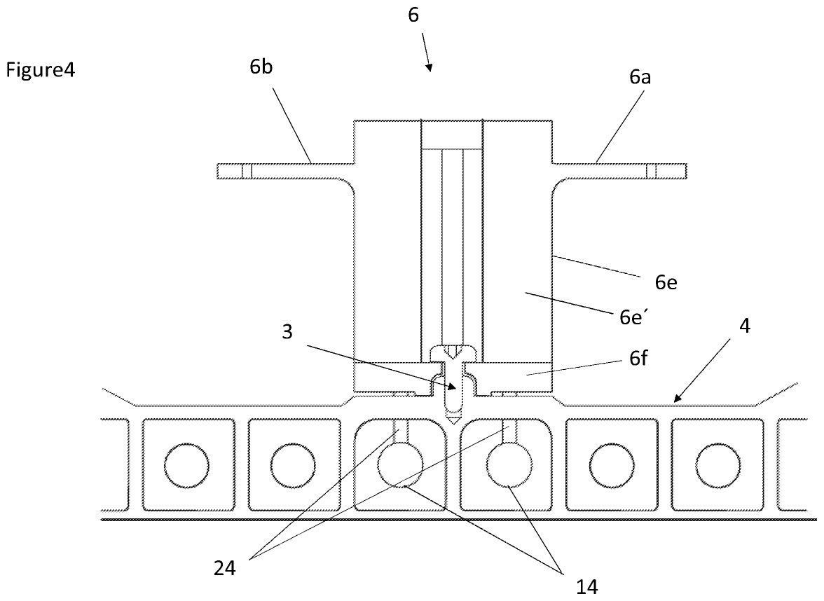

The radiating parts 6a-6d extend essentially in a plane parallel with the antenna reflector 4. The radiating parts 6a-6d are fed using the balun 6e, which also forms a mechanical support for the radiating parts 6a-6d. The balun 6e comprises a body part 6e′ and at least one inner conductor 24 (see FIG. 4) which may be positioned in the centre of a cylindrical hole in the body part. The body part 6e′ is connected to the outer conductor 15 and to the antenna reflector 4. The connection between said at least one balun inner conductor 24 and the feeding network coaxial line inner conductor 14 may be galvanic or indirect. An indirect connection may be either capacitive, inductive or a combination thereof and can be achieved by providing a thin insulating layer on at least the free end portion of the coupling element. The thin insulating layer could be provided by applying a thin layer of a polymer material, or by having a thin oxide layer, or by some other provisions applying an isolating layer. The insulating layer may have thickness of less than 50 μm, such as from 1 μm to 20 μm, such as from 5 μm to 15 μm, such as from 8 μm to 12 μm.

Referring to FIG. 4, there is illustrated a cross sectional view of a section of one of the radiating elements 6 shown in FIG. 3. The first part is here shown including only two radiating parts 6a-6b and the balun 6e. The cross section is cut-through the radiating element 6 and the inner conductors 14. The balun 6e and the balun body 6e″are also schematically depicted.

The radiating element 6 may be mechanically fixed to the reflector 4 using tightening means 3, such as a screw as shown in the Figure. Any suitable tightening means or fastener may be used. The screw presses the lower part 6f of the radiating element 6, which is also the balun bottom side, against the reflector 4 which also acts as the feeding network outer conductor. Thus, a galvanic connection may be established between the bottom side of balun outer conductor and the reflector and at the same time with the feeding network outer conductor.

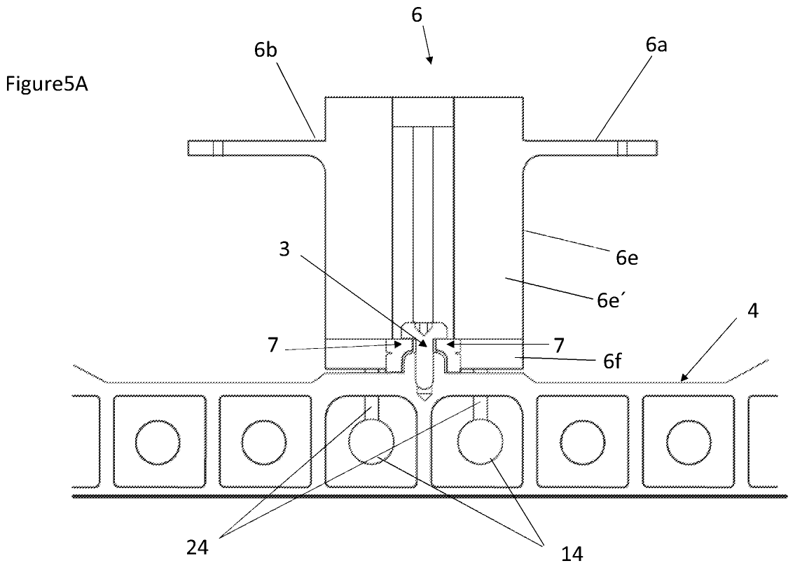

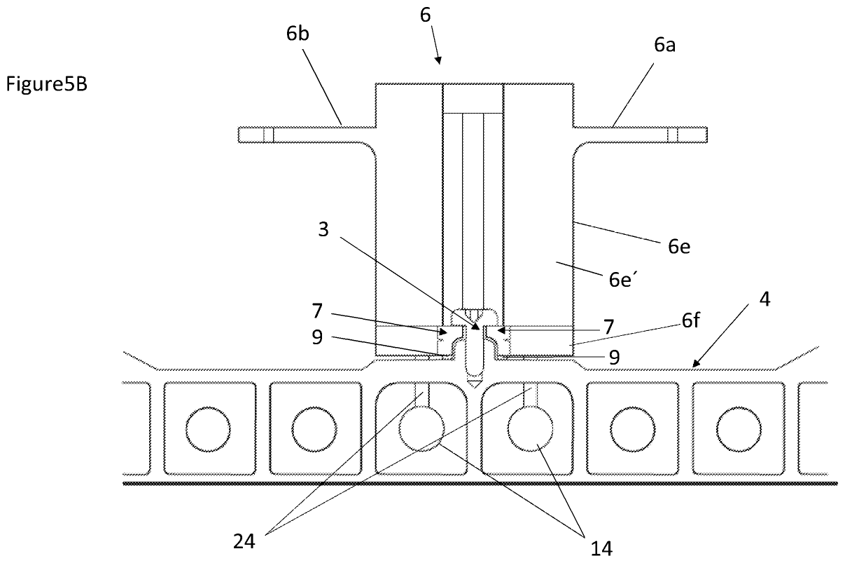

According to the present invention, and with reference to FIG. 5A, the radiating element 6 further comprises a second part 7 in the bottom/lower part 6f of the balun 6e or balun body 6e″. The second part 7 is provided in the lower part 6f of the radiating element 6 for connecting the radiating element 6 to the reflector by means of the screw or any suitable tightening means 3 or fastener.

Further, and according to the present invention, the first part of the radiating element 6 (forming the radiating parts and the balun) is made of a first metallic material, whereas the second part is made of a second metallic material being different from the first metallic material. The second part may be made as an insert element 7 in the bottom part 6f of the balun 6e.

Thus, the radiating element 6 is a combination of two different metallic materials exhibiting different properties in terms of creep and melting temperature. The second metallic material having less creep than the first metallic material. The first metallic material having a lower melting temperature than the second metallic material.

According to an embodiment of the present invention, the first metallic material of the first part is a zinc-based material and the second metallic material of the second part 7 is an aluminium-based material. Tests have shown that having a radiating element composed of a first part made of zinc and a second part 7 (or insert element) made of aluminium or silver-plated brass, the performance in terms of throughput and/or coverage is not degraded. Such a radiating element has similar performance as a radiating element manufactured only in aluminum. But the radiating element according to the present invention is less costly, easier to manufacture and does not require machining.

In addition, tests have also shown that radiating elements, according to invention, exhibit good PIM performance i.e. −110 dBm and below and therefore the performance of the antenna including such radiating elements is not reduced. This is because high pressure, applied by the tightening means (e.g. a screw) or fastener, necessary to obtain low PIM is only applied to materials with low creep e.g. aluminium of which the insert element and the reflector are made of. The interface between the aluminium-made insert element (second part 7) of the radiating element and the zinc-made first part of the radiating element is not subject to high pressure, and hence creep will not occur. In addition, the low PIM performance of the radiating element does not deteriorate with time. As shown in FIG. 5A, the radiating element 6 is attached to the reflector 4 by means of a screw or tightening/fastening means 3 passing through the hole of the insert element 7.

Further, the good PIM performance is maintained even after accelerated life testing including temperature cycling, high and low temperature tests, humidity, salt spray and vibration.

Instead of aluminium, the insert element 7 or the second part 7 of the radiating element 6 may be made of brass or any other metal material which has good creep properties and thus may be advantageously used to make low PIM contacts between metal parts.

According to an embodiment, the insert element 7 may be galvanically connected to the bottom part of the balun part 6e or capacitively connected to the bottom part of the balun part 6e. The insert element 7 may be cylindrical but other forms could be used e.g. square or elliptical.

According to yet another embodiment and with reference to FIG. 5B, the antenna arrangement may be provided with a metal-based washer 9 including a central hole, the washer 9 being placed in-between the insert element 7 of the radiating element 6 and the reflector 4 allowing the tightening means 3 holding the radiating element 6 to the reflector 4 to pass through the hole of the insert element 7 and the hole of the washer 9. The washer 9 may be made in a metallic material which is harder than the metallic material of the reflector 4.

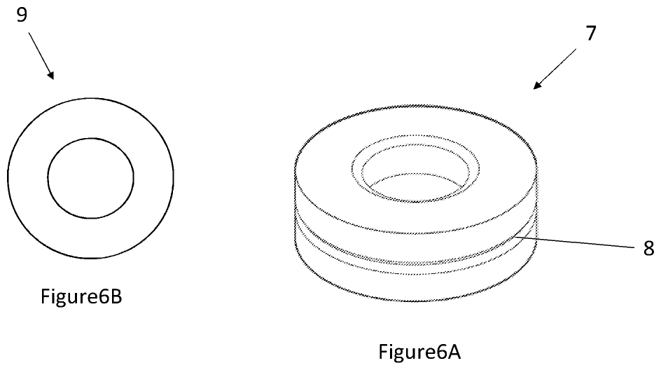

As an example, if the insert element 7 is made in aluminium and is to be attached/connected to an aluminium antenna reflector 4, it might be difficult to achieve a galvanic connection if the insert element 7 or the antenna reflector have acquired an isolating oxide layer. This is because aluminium is a rather soft metal. In this case, it may be advantageous to use a small washer of brass 9 or some other metal which is harder than aluminium between the radiating element 6 and the antenna reflector 4. An example of a washer 9 made of brass is shown in FIG. 6B. The washer 9 may be placed around the tightening means or screw holding the radiating element. If the washer 9 is in brass and in order to avoid oxidation corrosion, the washer 9 may be e.g. silver-plated. The bottom of the radiating element 6, or the antenna reflector 4, may be made to have a shape which helps to locate the washer 9 in its correct position.

According to another embodiment, the insert element 7 includes at least one groove 8 and/or at least one protrusion. A groove or a protrusion in a cylindrical surface of the insert element 7 may be used to better hold the insert element 7 into the radiating element. FIG. 6A shows a cylindrical insert element 7 with a groove 8. The insert element 7 may be a small part only located close to the mechanical interface between the radiating element 6 and the reflector 4, or it may be larger, and form the lower part of the balun 6e, or even form the whole balun 6e.

The shape of the insert element side connecting to the reflector 4 may be optimised to achieve best PIM performance. As an example, the surface contacting the reflector 4 may be reduced to a minimum to achieve a low PIM. The insert element 7 may have different types of surface treatments. For example, an insert element 7 made of brass may be silver-plated in order to avoid oxidation corrosion.

According to another embodiment, the insert element 7 is capacitively connected to the bottom part 6f of the balun part 6e or balun body. As an example, the insert element 7 may be capacitively connected to the zinc part of the radiating element 6 or the zinc part of the balun bottom part 6f of the radiating element 6.This may be achieved by anodizing the insert element 7 in order to get a thin isolating layer, but other types of isolating layers could also be used.

According to yet another aspect of the present invention, a method of manufacturing a radiating element by die casting is provided. As previously described, the radiating element is a combination of two different metallic materials having different properties. As an example, a radiating element made in zinc is combined with an insert element made in a metallic material with higher melting temperature than that of zinc, and hence with lower creep, such as aluminium or brass. The method of die casting comprises: placing the insert element (second metallic material) in the die cast mold cavity representing (the form of) the radiating element, before forcing zinc (first metallic material) in molten form under high pressure into it. Hence, the insert element will form an integral part together with the radiating element substantially manufactured in zinc. Additional details on the radiating element and the antenna arrangement comprising radiating elements according to the present invention have already been described and need not be repeated again.

The description above and the appended drawings are to be considered as non-limiting examples of the invention. The person skilled in the art realizes that several changes and modifications may be made within the scope of the invention. For example, the number of radiating parts/dipoles may be varied and also the shape of the radiating element may be varied. Furthermore, the reflector does not necessarily need to be formed integrally with the coaxial lines, but may on the contrary be a separate element. Further, the radiating elements may be connected to soft or semi-rigid coaxial cables. The scope of protection is determined by the appended patent claims.

1. An antenna arrangement comprising an antenna feeding network, an electrically conductive reflector and at least one radiating element arranged on said reflector, the radiating element having a first part comprising radiating parts forming a dipole, and a balun part; said first part being made of a first metallic material; and
a second part made of a second metallic material being different than the first metallic material, said second part being provided in the lower part (6f) of the radiating element for connecting the radiating element to the reflector.

2. The antenna arrangement according to claim 1 wherein the second metallic material has less creep than the first metallic material.

3. The antenna arrangement according to claim 1 wherein the second part is made as an insert element in the bottom part (6f) of the balun part.

4. The antenna arrangement according to claim 1 wherein the first metallic material has a lower melting temperature than the second metallic material.

5. The antenna arrangement according to claim 1 wherein the first metallic material is a zinc-based material and the second metallic material is an aluminium-based material or a brass-based material.

6. The antenna arrangement according to claim 3 wherein the insert element is galvanically connected to the bottom part of the balun part or capacitively connected to the bottom part of the balun part.

7. The antenna arrangement according to claim 3, wherein the radiating element is attached to the reflector by using tightening means passing through a hole of the insert element.

8. The antenna arrangement according to claim 3 wherein the insert element includes at least one groove and/or at least one protrusion.

9. The antenna arrangement according to claim 7 further comprises a metal-based washer including a central hole, the washer being placed in-between the insert element and the reflector allowing the screw holding the radiating element to the reflector to pass through the hole of the insert element and the hole of the washer.

10. The antenna arrangement according to claim 9 wherein the metal-based washer is made in a metallic material which is harder than the metallic material of the reflector.

11. The antenna arrangement according to claim 9 wherein the metal-based washer is made in a metallic material which is harder than the second metallic material of the radiating element.

12. A radiating element for an antenna arrangement comprising an antenna feeding network and an electrically conductive reflector; the radiating element having a first part comprising radiating parts forming a dipole and a balun part; said first part being made of a first metallic material; a second part being provided in the lower part of the radiating element for connecting the radiating element to the reflector; wherein the second part is made of a second metallic material being different than the first metallic material.

13. The radiating element according to claim 12 wherein the second metallic material has less creep than the first metallic material.

14. The radiating element according to claim 12 wherein the second part is made as an insert element in the bottom part of the balun part.

15. The radiating element according to claim 12 wherein the first metallic material has a lower melting temperature than the second metallic material.

16. The radiating element according to claim 12 wherein the first metallic material is a zinc-based material and the second metallic material is an aluminium-based material or a brass-based material.

17. The radiating element according to claim 14 wherein the insert element is galvanically connected to the bottom part of the balun part or capacitively connected to the bottom part of the balun part.

18. The radiating element according to claim 14, is configured to be attached to the reflector using tightening means passing through a hole of the insert element.

19. The radiating element according to claim 14 wherein the insert element includes at least one groove and/or at least one protrusion.

20. A method of die casting a radiating element for an antenna arrangement comprising:
placing an insert element in a die cast mold cavity representing the radiating element;
forcing a first metallic material, in molten form, under high pressure into the mold cavity;
wherein the insert element is made of a second metallic material being different than the first metallic material.

21. The method according to claim 20 wherein the second metallic material has less creep than the first metallic material.

22. The method according to claim 20 wherein the first metallic material is a zinc-based material and the second metallic material is an aluminium-based material or a brass-based material.
